(19) United States
(12) Patent Application Publication
(10) Pub. No.: US 2014/0088765 A1
(43) Pub. Date: Mar. 27, 2014

(54) METHOD FOR INVALIDATING SENSOR MEASUREMENTS AFTER A PICKING ACTION IN A ROBOT SYSTEM

(71) Applicants: Harri Valpola, Helsinki (FI); Tuomas Lukka, Helsinki (FI)

(72) Inventors: Harri Valpola, Helsinki (FI); Tuomas Lukka, Helsinki (FI)

(73) Assignee: ZENROBOTICS OY, Helsinki (FI)

(21) Appl. No.: 14/110,238

(22) PCT Filed: Mar. 28, 2012
(86) PCT No.: PCT/FI2012/050307

§ 371 Date: Dec. 2, 2013

(30) Foreign Application Priority Data
Apr. 5, 2011 (FI) 20115326

(51) Int. Cl. B25J 9/16

(52) U.S. Cl. CPC B25J 9/1697; Y10S 901/47; Y10S 901/31
USPC 700/259

(57) ABSTRACT

The invention relates to a method and system for invalidating sensor measurements after a sorting action on a target area of a robot sorting system. In the method there are obtained sensor measurements using sensors from a target area. A first image is captured of the target area using a sensor over the target area. A first sorting action is performed in the target area using a robot arm based on the sensor measurements and the first image. Thereupon, a second image of the target area is captured using a sensor over the target area. The first and the second images are compared to determine invalid areas in the target area. The invalid areas are avoided in future sorting actions based on the sensor measurements.

### BACKGROUND OF THE INVENTION

1. Field of the Invention

The present invention relates to systems and methods used for manipulating physical objects with a robot arm and a gripper. In particular, the present invention relates to a method for invalidating sensor measurements after a picking action in a robot system.

2. Description of the Related Art

Robot system may be used in the sorting and classification of a variety of physical objects such as manufacturing components, machine parts and material to be recycled. The sorting and classification requires that the physical objects may be recognized with sufficient probability. In applications such as recycling and waste management, it is important that the purity of a sorted group of objects is high, namely, that as few as possible objects of a wrong type end up in the sorted groups of objects. The sorted groups typically comprise glass, plastic, metal, paper and biological waste. The objects to be sorted are usually provided on a conveyer belt to a robot system comprising at least one robot arm for sorting the objects to a number of target bins.

In robot systems the recognition of physical objects to be moved or manipulated may employ different types of sensors. A first type of sensors may comprise sensors that are used to form an image of an entire target area. The image of the target area may be produced, for example, using visible light or infrared electromagnetic radiation. A second type of sensors comprises sensors which require moving the imaged objects across the sensors field of view. A typical example of such sensors is line scanner sensors arranged over a conveyer belt. The line scanner sensors may be arranged as a row of a number of equally spaced sensors. Each line scanner sensor is responsible for obtaining an array of readings on a longitudinal stripe of the conveyer belt. The arrays from each line scanner sensor may be combined to form a matrix of sensor readings. Examples of such sensors may be infrared scanners, metal detectors and laser scanners. The distinguishing feature of the second type of sensors is that they may not form the matrix of sensor readings without moving imaged objects, in the above example without moving the conveyer belt. The problem with the second type of sensors is the need for moving the imaged objects or sensors with respect to one another.

Always when a robot arm picks or attempts to pick an object from the area that has been used to form the matrix of sensor readings, the matrix becomes at least partly invalid. The changes caused by the picking action are not restricted to the object that is picked or attempted to be picked in some cases. On a conveyer belt containing target objects arranged in an unstructured manner, for example, waste to be sorted, the objects may be connected to each other and on top of each other, at least partly. Therefore, after a picking action at least some of the objects may be no longer in the place that they used to be in when the matrix was formed. It would be necessary to move the conveyer belt again below the same array of line sensors to form a similar matrix. This renders it necessary to move the conveyer belt back and forth after each picking action by a robot arm. The problem is the same for other setups for moving objects, such as rotating platters. Acquiring a second reading with such sensors consumes energy and time. Therefore, it would be beneficial to be able to repeat picking actions using at least partly the same line sensor reading matrix.

### SUMMARY OF THE INVENTION

According to a first aspect of the invention, the invention is a method comprising: obtaining at least two sensor measurements using at least one sensor from a target area; forming a first image of the target area; performing a first sorting action in the target area based on at least a first sensor measurement among the at least two sensor measurements; forming a second image of the target area; comparing the first image and the second image to determine at least one invalid area in the target area; and avoiding the invalid area in at least one second sorting action in the target area, the second sorting action being based on at least a second sensor measurement among the at least two sensor measurements.

According to a further aspect of the invention, the invention is an apparatus comprising: means for obtaining at least two sensor measurements using at least one sensor from a target area; means for forming a first image of the target area; means for performing a first sorting action in the target area based on a first sensor measurement among the at least two sensor measurements; means for forming a second image of the target area; means for comparing the first image and the second image to determine at least one invalid area in the target area; and means for avoiding the invalid area in at least one second sorting action in the target area, the second sorting action being based on at least a second sensor measurement among the at least two sensor measurements.

According to a further aspect of the invention, the invention is a computer program comprising code adapted to cause a processor to perform the following steps when executed on a data-processing system: obtaining at least two sensor measurements using at least one sensor from a target area; forming a first image of the target area; performing a first sorting action in the target area based on at least a first sensor measurement among the at least two sensor measurements; forming a second image of the target area; comparing the first image and the second image to determine at least one invalid area in the target area; and avoiding the invalid area in at least one second sorting action in the target area, the second sorting action being based on at least a second sensor measurement among the at least two sensor measurements.

According to a further aspect of the invention, the invention is an apparatus comprising: comprising at least one processor configured to obtain at least two sensor measurements using at least one sensor from a target area, to form a first image of the target area, to perform a first sorting action in the target area based on at least a first sensor measurement among the at least two sensor measurements, to form a second image of the target area, to compare the first image and the second image to determine at least one invalid area in the target area, and to avoid the invalid area in at least one second sorting action in the target area, the second sorting action being based on at least a second sensor measurement among the at least two sensor measurements.

In one embodiment of the invention, the sorting action is performed using a robot arm.

In one embodiment of the invention, an image, such as the first image and the second image may be any kind of sensor data that may be represented or interpreted as a two-dimensional matrix or array, or a three-dimensional array.

In one embodiment of the invention, an image, such as the first and the second image may be monochromatic or multi-color photographs. Monochrome images in neutral colors are called grayscale or black-and-white images.

In one embodiment of the invention, an image, such as the first image and the second image may comprise at least one of a photograph and a height map. A height map may comprise a two-dimensional array or matrix of height values at a given point. A height map may also be a three-dimensional model of a target area. The three-dimensional model may comprise, for example, at least one of a set of points, a set of lines, a set of vectors, a set of planes, a set of triangles, a set of arbitrary geographic shapes. A height map may be associated with an image, for example, as metadata.

In one embodiment of the invention, an image, such as the first image and the second image may be a height map. In one embodiment of the invention, the height map is captured using a 3D line scanner.

In one embodiment of the invention, by an image may be meant a collection of data comprising at least one of a photographic image and a height map. The photographic image may be 2D or 3D.

In one embodiment of the invention, an image, such as the first image and the second image may have associated with it as part of the image a height map in addition to another representation of the image.

In one embodiment of the invention, a height map is captured using a 3D line scanner. The line scanner may be a laser line scanner. For example, a laser line scanner may comprise a balanced, rotating mirror and motor with position encoder, and mounting hardware. The scanner deflects a sensor's laser beam degrees, sweeping it through a full circle as it rotates.

In one embodiment of the invention, the step of comparing of the first and the second image to determine at least one invalid area in the target area further comprises comparing a height of an area in the first image and the second image. The area may be of an arbitrary size or form. The first and the second image may be height maps or they may have associated with them separate height maps.

In one embodiment of the invention, the step of comparing of the first image and the second image to determine at least one invalid area in the target area further comprises choosing one of the height maps of the first image or the second image, producing from the chosen height map two new height maps, which may be referred to as a min-map and a max-map, the min-map being computed pixel-wise using the formula: min-map=erode(heightmap)−fudgefactor, the max-map being computed pixel-wise using the formula: max-map=dilate(heightmap)+fudgefactor, comparing a second height map h2, that is, the other height map, to the chosen height map h1 by checking for each pixel h2(x,y) in the second height map whether the condition min-map(x,y)<h2(x,y)<max-map(x,y) is fulfilled, and selecting to the at least one invalid area pixels (x,y) for which the condition is not fulfilled. The dilate function is the morphologic dilation operator. The erode function is the morphologic erosion operator. The fudge factor is a constant or a pixel dependent array of constants.

In one embodiment of the invention, the step of comparing the first image and the second image to determine at least one invalid area in the target area further comprises forming an upper limit surface of a chosen height map, the chosen height map being the height map of the first image or the second image, forming a lower limit surface of the chosen height map, and selecting to the at least one invalid area such areas where the other height map does not fit between the upper limit surface and the lower limit surface, the other height map being the height map of the first image or the second image.

In one embodiment of the invention, the step of comparing the first image and the second image to determine at least one invalid area in the target area further comprises assigning as a first height map a height map associated with either the first image or the second image, assigning as a second height map a height map associated with the other image, forming an upper limit surface of the first height map, forming a lower limit surface of the first height map, and selecting to the at least one invalid area such areas where the second height map does not fit between the upper limit surface and the lower limit surface. There is a height map associated with the first image and a height map associated with the second image.

In one embodiment of the invention, the step of comparing the first image and the second image to determine at least one invalid area in the target area further comprises assigning as a first height map either the first image or the second image, assigning as a second height map the other image, forming an upper limit surface of the first height map, forming a lower limit surface of the first height map, and selecting to the at least one invalid area such areas where the second height map does not fit between the upper limit surface and the lower limit surface. In this embodiment the first image and the second image are height maps.

In one embodiment of the invention, the upper limit surface is computed pixel-wise using the morphologic dilation operator. The dilation function may be defined so that the value of the output pixel is the maximum value of all the pixels in the input pixel's neighborhood. In a binary image, if any of the pixels is set to the value 1, the output pixel is set to 1. A fudge factor may be added or subtracted in the computation to the value provided by the dilation function.

In one embodiment of the invention, the lower limit surface is computed pixel-wise using the morphologic erosion operator, erode. The erode function may be defined so that the value of the output pixel is the minimum value of all the pixels in the input pixel's neighborhood. In a binary image, if any of the pixels is set to 0, the output pixel is set to 0. A fudge factor may be added or subtracted in the computation to the value provided by the erosion function.

In one embodiment of the invention, the sorting action is a picking action performed using the robot hand. The picking action may also be referred to as gripping.

The sorting action may be an unsuccessful picking action. The sorting action may be a moving, an attempted moving or touching of at least one object in the target area. The moving may be in any direction.

In one embodiment of the invention, the first sorting action in the target area may be performed using the robot arm based on at least the first sensor measurement among the at least two sensor measurements and the first image.

In one embodiment of the invention, the second picking action may be based on at least the second sensor measurement among the at least two sensor measurements together with the at least one of the first image and the second image.

In one embodiment of the invention, the first sensor measurement is measured in the invalid area and the second sensor measurement is not measured in the invalid area.

In one embodiment of the invention, the first image is formed by capturing an image of the target area using a first camera and the second image is formed by capturing an image of the target area using a second camera.

In one embodiment of the invention, the method further comprises running a conveyor belt on which the target area is located a predefined length, the predefined length corresponding to a distance between the first camera and a second camera.

In one embodiment of the invention, the method further comprises transforming at least one of the first image and the second image to a coordinate system shared by the first image and the second image using perspective correction. The perspective correction may compensate differences regarding at least one of the angles of view of the first camera and the second camera towards the conveyer belt, and the differences regarding the distances of the first camera and the second camera to the conveyer belt. The perspective correction may comprise, for example, correcting at least one of vertical and horizontal tilt between the first image and the second image.

In one embodiment of the invention, the method further comprises determining the perspective correction using a test object with a known form. The perspective correction may be defined by capturing a plurality of first test images using the first camera and a plurality of second test images using the second camera while the conveyer belt is run and selecting best matching images among the first test images and the second test images representing the test object. The perspective correction may be defined as the transformation necessary to translate a best matching first test image and a best second best matching test image to a common coordinate system.

In one embodiment of the invention, the method further comprises capturing a plurality of first test images using the first camera and a plurality of second test images using the second camera while the conveyer belt is run; selecting best matching images among the first test images and the second images representing the test object; and recording the length the conveyer belt has been run between the images as the predefined length.

In one embodiment of the invention, the method further comprises high-pass filtering at least one of the first image and the second image.

In one embodiment of the invention, the step of comparing the first and the second image further comprises forming a plurality of areas of the first image and the second image, the plurality of areas being at least partly overlapping or distinct. The plurality of areas may be formed of the entire areas of the first and the second images with a window function. The window function may be, for example, rectangular or it may be a Gaussian window function. The areas may be pixel blocks of defined height and width such as, for example, 30 times 30 pixels. The plurality of areas may have the same pixels in the first and the second images and may have the same sizes.

In one embodiment of the invention, the step of comparing the first image and the second image further comprises smoothing each of the plurality of areas with a smoothing function. The smoothing function may be a Gaussian kernel.

In one embodiment of the invention, the step of comparing the first and the second image further comprises determining a plurality of areas as the at least one invalid area based on a low correlation between the first image and the second image and high variance within the first image.

In one embodiment of the invention, the step of determining a plurality of areas as the at least one invalid area further comprises: selecting a maximum correlation yielding displacement between the first image and the second image for each area; and computing the correlation between the first image and the second image for each area using the maximum correlation yielding displacement. The displacement is a displacement of a given number of pixels in horizontal or vertical direction. The number of pixels may be, for example, less than, for example, five or three in pixels in either direction. The maximum correlation yielding displacement may be determined by attempting each of the displacements separately in horizontal or vertical direction.

In one embodiment of the invention, the step of comparing the first and the second image further comprises: determining a plurality of areas within the first image with highest variance within the area.

In one embodiment of the invention, the step of comparing the first and the second image further comprises: determining a plurality of areas with lowest correlation between the first image and the second image; and determining the areas with highest variance and lowest correlation as the at least one invalid area.

In one embodiment of the invention, as selection criteria for invalid areas may also be used a threshold for local variance within the first image that must be exceeded and a threshold for local correlation between the first image and the second that must not be exceeded for an area to qualify as an invalid area.

In one embodiment of the invention, the at least one sensor comprises an infrared sensor, a metal detector and a laser scanner. The infrared sensor may be a Near Infrared (NIR) sensor.

In one embodiment of the invention, the camera is a visible light camera, time of flight 3D camera, structured light 3D camera or an infrared camera or a 3D camera.

In one embodiment of the invention, the first image and the second image are formed using a single 3D camera, which may be, for example, a time-of-flight 3D camera or a structured light 3D camera.

In one embodiment of the invention, the success of a gripping or picking action is determined using data from sensors. If the grip is not successful, the robot arm is then moved to different location for another attempt.

In one embodiment of the invention, the system is further improved by utilizing learning systems, which may run in the apparatus.

In one embodiment of the invention, the computer program is stored on a computer readable medium. The computer readable medium may be a removable memory card, a removable memory module, a magnetic disk, an optical disk, a holographic memory or a magnetic tape. A removable memory module may be, for example, a USB memory stick, a PCMCIA card or a smart memory card.

In one embodiment of the invention, instead of two cameras to capture the first and the second images may be used a three-dimensional image capturing camera. The three-dimensional image capturing camera may comprise two lenses and image sensors.

In one embodiment of the invention, a first sensor array and a second sensor array may be moved over a stationary target area in order to form the matrixes of sensor readings from the first sensor array and the second sensor array. In this case there is no conveyer belt. The objects to be picked may be placed on a stationary target area. In this case also a single 2D camera or a single 3D camera may be used to capture the first and the second images.

In one embodiment of the invention, the conveyer belt may be replaced with a rotating disk or platter on which the objects to be picked are placed. In this case the first sensor array and the second sensor array are placed along the direction of disk or platter radius.

The embodiments of the invention described hereinbefore may be used in any combination with each other. Several of the embodiments may be combined together to form a further embodiment of the invention. A method, a system, an apparatus, a computer program or a computer program product to which the invention is related may comprise at least one of the embodiments of the invention described hereinbefore.

The benefits of the invention are related to improved quality in the selection of objects from an operating space of a robot. The information on invalid areas for subsequent picking actions makes it unnecessary to move the conveyer belt back and forth after each picking action by a robot arm due to the fact that sensor information may become partly stale after each picking action. This saves energy and processing time of the robot system.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a robot system applying two line sensor arrays in one embodiment of the invention;

FIG. 2 illustrates a calibration of two cameras using a calibration object placed on the conveyer belt in one embodiment of the invention; and

FIG. 3 is a flow chart illustrating a method for invalidating sensor measurements after a picking action in a robot system in one embodiment of the invention;

FIG. 4 is a flow chart illustrating a method for invalidating sensor measurements after a picking action in a robot system in one embodiment of the invention; and

FIG. 5 is a flow chart illustrating a method for determining invalid image areas within a target area in a robot system in one embodiment of the invention.

### DETAILED DESCRIPTION OF THE EMBODIMENTS

Reference will now be made in detail to the embodiments of the present invention, examples of which are illustrated in the accompanying drawings.

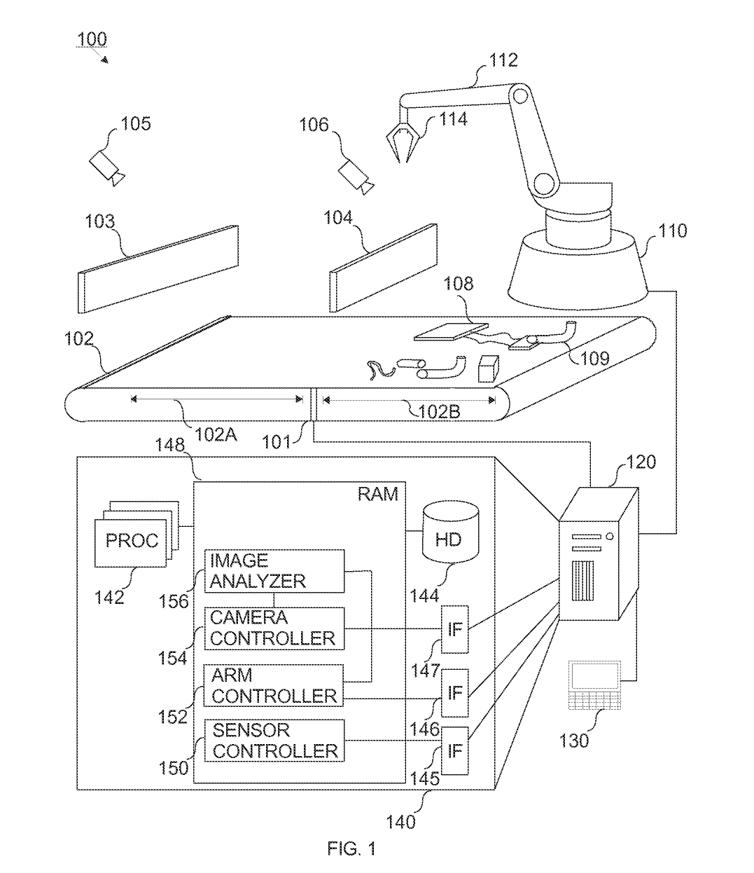

FIG. 1 is a block diagram illustrating a robot system applying two line sensor arrays in one embodiment of the invention.

In FIG. 1 robot system 100 comprises is a robot 110, for example, an industrial robot comprising a robot arm 112. To robot arm 116 is connected a gripper 114, which may also be a clamp or a claw. Robot arm 116 is capable of moving gripper 112 within an operating area 102B of a conveyer belt 102. Robot arm 112 may comprise a number of motors, for example, servo motors that enable the robot arms rotation, elevation and gripping to be controlled. Various movements of robot arm 112 and gripper 114 are effected by actuators. By way of example, the actuators can be electric, pneumatic or hydraulic, or any combination of these. The actuators may move or rotate various elements of robot 110. In association with robot 110 there is a computer unit (not shown) which translates target coordinates for gripper 114 and robot arm 112 to appropriate voltage and power levels inputted to the actuators controlling robot arm 112 and gripper 114. The computer unit in association with robot 110 is controlled using a connector, for example, an USB connector which is used to carry target coordinate specifying gripping instructions from an apparatus 120 to the computer unit. In response to control signals from the apparatus 120, the actuators perform various mechanical functions including but not necessarily limited to: positioning gripper 114 over a specific location within operating area 102B, lowering or raising gripper 114, and closing and opening of gripper 114. Robot 110 may comprise various sensors. By way of example, the sensors comprise various position sensors (not shown) which indicate the position of robot arm 112 and gripper 114, as well as the open/close status of gripper 114. The open/close status of the gripper is not restricted to a simple yes/no bit. In one embodiment of the invention, gripper 114 may indicate a multi-bit open/close status in respect of each of its fingers, whereby an indication of the size and/or shape of the object(s) in the gripper may be obtained. In addition to the position sensors, the set of sensors may comprise strain sensors, also known as strain gauges or force feedback sensors, which indicate strain experienced by various elements of robot arm 112 and gripper 114. In an illustrative but non-restrictive implementation example, the strain sensors comprise variable resistances whose resistance varies depending on the tension of compression applied to them. Because the changes in resistance are small compared to the absolute value of the resistance, the variable resistances are typically measured in a Wheatstone bridge configuration.

In FIG. 1 there is illustrated a conveyer belt 102. On the conveyer belt there is illustrated a number of objects to be sorted by robot 110 to a number of target bins (not shown), for example, an object 108 and an object 109. Over the conveyer belt 102 there are illustrated two line sensor arrays, namely, sensor array 103 and sensor array 104. The sensor arrays comprise a number of equally spaced sensors that obtain arrays of readings from stripes of conveyer belt 102 below the respective sensors. The sensor arrays may be placed so that they are orthogonal to the side of conveyer belt 102. In one embodiment of the invention, the sensors in sensor arrays may not be equally spaced and the sensor array may be placed at a non-orthogonal angle in relation to the side of conveyer belt 102. The sensors in a sensor array may be stationary or they may be moved to scan a wider stripe of conveyer belt 102. Sensor array 103 may be, for example, a Near Infrared (NIR) sensor array. Sensor array 104 may be, for example, a Laser scanner array. Each sensor array is responsible for obtaining an array, that is, a time series of readings on a longitudinal stripe of the conveyer belt. The arrays from each sensor array may be combined to form a matrix of sensor readings.

Conveyer belt 102 is divided to two logical areas, namely, a first area 102A and a second area 102B. The first area 102A may be called a pristine area where objects on conveyer belt 102 are not moved. The second area 102B is the operating area of robot 110 where robot 110 may grip or attempt to grip objects such as object 108. Object 108 is illustrated to be comprised of two parts connected by electrical cords. The moving of the first part causes the moving of the second part, which in turn causes the moving of object 109, which is partly over the second part of object 108. Therefore, the moving of object 108 within area 102B causes the invalidation of an area of sensor readings within the matrix, that is, a number of matrix elements. For each matrix element it is assumed that apparatus 120 knows the area corresponding to the element within second area 102B.

In FIG. 1 there is a first camera 105 which is arranged to obtain a first image, which is taken from area 102A. There is also a second camera 106 which is arranged to obtain a second image, which is in turn taken from area 102B. The first image is taken to determine the arrangement of objects on conveyer belt 102 before a gripping action is taken. The second image is taken to determine the arrangement of objects after a gripping action has been taken. The gripping action may be successful or unsuccessful. There is a specific sensor 101 which may be called a belt encoder which is used to determine the correct offset of belt positions that enables the obtaining of corresponding first and second images where objects not moved with respect to the belt surface appear in approximately same positions. Belt encoder 101 is used to determine the number of steps that conveyer belt 102 has been run during a given time window.

Robot 110 is connected to data processing apparatus 120, in short apparatus 120. The internal functions of apparatus 120 are illustrated with box 140. Apparatus 120 comprises at least one processor 142, a Random Access Memory (RAM) 148 and a hard disk 144. The one or more processors 142 control the robot arm by executing software entities 150, 152, 154 and 156. Apparatus 120 comprises also at least a camera interface 147, a robot interface 146 to control robot 110 and a sensor interface 145. Robot interface 146 may also be assumed to control the movement of conveyer belt 102. Interfaces 145, 146 and 147 may be bus interfaces, for example, a Universal Serial Bus (USB) interfaces. To apparatus 120 is connected also a terminal 130, which comprises at least a display and a keyboard. Terminal 130 may be a laptop connected using a local area network to apparatus 120.

The memory 148 of apparatus 120 contains a collection of programs or, generally, software entities that are executed by the at least one processor 142. There is a sensor controller entity 150 which obtains a matrix of sensor readings from sensor array 103 and a matrix of sensor readings from sensor array 104 via interface 145. Elements in the matrixes represent a sensor reading from a given sensor within a given sensor array at a given moment in time while conveyer belt 102 is run. There is an arm controller entity 152 which issues instructions via robot interface 146 to robot 110 in order to control the rotation, elevation and gripping of robot arm 116 and gripper 112. Arm controller entity 152 may also receive sensor data pertaining to the measured rotation, elevation and gripping of robot arm 112 and gripper 114. Arm controller may actuate the arm with new instructions issued based on feedback received to apparatus 120 via interface 146. Arm controller entity 152 is configured to issue instructions to robot 110 to perform well-defined high-level operations. An example of a high-level operation is moving the robot arm to a specified position. There is also a camera controller entity 154 communicates with cameras 105 and 106 using interface 147. Camera controller entity causes cameras 105 and 106 to take pictures at specified moments in time. Camera controller entity 154 obtains the pictures taken by cameras 105 and 106 via interface 147 and stores the pictures in memory 140.

The sensor controller entity 150 may obtain at least one sensor measurement using at least one sensor from a target area on a conveyor belt 102. Camera controller entity 154 may capture a first image of the target area using a first camera. Arm controller entity 152 may run the conveyor belt a predefined length, the predefined length corresponding to a distance between the first camera and a second camera. Arm controller entity 152 may perform a first picking or sorting action in the target area using a robot arm based on at least one of the at least one sensor measurement and the first image. Camera controller entity 154 may capture a second image of the target area using the second camera. Image analyzer entity 156 may compare the first and the second image to determine at least one invalid area in the target area and instruct the arm controller entity 152 to avoid the invalid area in at least one second picking or sorting action in the target area.

When at least one processor executes functional entities associated with the invention, a memory comprises entities such as sensor controller entity 150, arm controller entity 152, camera controller entity 154 and image analyzer entity 156. The functional entities within apparatus 120 illustrated in FIG. 1 may be implemented in a variety of ways. They may be implemented as processes executed under the native operating system of the network node. The entities may be implemented as separate processes or threads or so that a number of different entities are implemented by means of one process or thread. A process or a thread may be the instance of a program block comprising a number of routines, that is, for example, procedures and functions. The functional entities may be implemented as separate computer programs or as a single computer program comprising several routines or functions implementing the entities. The program blocks are stored on at least one computer readable medium such as, for example, a memory circuit, memory card, magnetic or optic disk. Some functional entities may be implemented as program modules linked to another functional entity. The functional entities in FIG. 1 may also be stored in separate memories and executed by separate processors, which communicate, for example, via a message bus or an internal network within the network node. An example of such a message bus is the Peripheral Component Interconnect (PCI) bus.

In one embodiment of the invention, software entities 150-156 may be implemented as separate software entities such as, for example, subroutines, processes, threads, methods, objects, modules and program code sequences. They may also be just logical functionalities within the software in apparatus 120, which have not been grouped to any specific separate subroutines, processes, threads, methods, objects, modules and program code sequences. Their functions may be spread throughout the software of apparatus 120. Some functions may be performed in the operating system of apparatus 120.

In one embodiment of the invention, instead of cameras 105 and 106 may be used a three-dimensional image capturing camera. The three-dimensional image capturing camera may comprise two lenses and image sensors. In one embodiment of the invention, the camera is a visible light camera, time of flight 3D camera, structured light 3D camera or an infrared camera or a 3D camera.

In one embodiment of the invention, a 3D line scanner may be used in place or in addition to the camera.

In one embodiment of the invention, an image, such as the first image and the second image may be any kind of sensor data that may be represented or interpreted as a two-dimensional matrix or array, or a three-dimensional array.

In one embodiment of the invention, sensor array 103 and sensor array 104 may be moved over a stationary target area in order to form the matrixes of sensor readings from sensor array 103 and sensor array 104. In this case there is no conveyer belt. The objects to be picked may be placed on a stationary target area. In this case also a single 2D camera or a single 3D camera may be used to capture the first and the second images.

In one embodiment of the invention, conveyer belt 102 may be replaced with a rotating disk or platter on which the objects to be picked are placed. In this case sensor array 103 and sensor array 104 are placed along the direction of disk or platter radius. In this case first area 102A and second area 102B are sectors in the disk or platter.

The embodiments of the invention described hereinbefore regarding FIG. 1 may be used in any combination with each other. Several of the embodiments may be combined together to form a further embodiment of the invention.

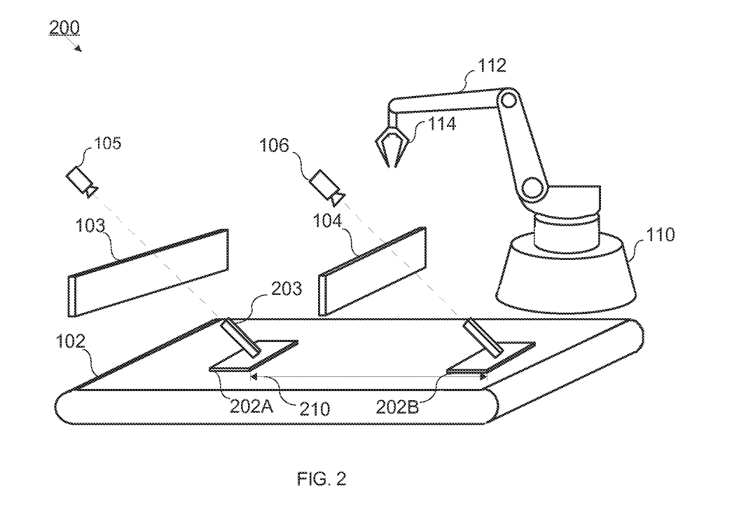

FIG. 2 illustrates a calibration of two cameras using a calibration object placed on the conveyer belt in one embodiment of the invention.

In the arrangement 200 of FIG. 2 there is a calibration object, which is illustrated at two conveyer belt 102 positions as objects 202A and 202B. The calibration object comprises an arm 203 that is arranged to point directly to camera 105. Arm 203 may be arranged so that it is perpendicular to the plane of the lens in camera 105. Cameras 105 and 106 each take a plurality of pictures while conveyer belt 102 is run. From the images are selected a first image from camera 105 and a second image from camera 106. The first and the second images are selected so that arm 203 points directly to camera 105 in the first image and to camera 106 in the second image. Generally, best matching images taken by cameras 105 and 106 are selected as the first image and the second image. The distance that conveyer belt 102 has been run between the taking of the first image and the second image is recorded as a belt offset 210. Belt offset 210 may be recorded as a number of belt steps. The belt steps may be obtained from belt encoder 101. While conveyer belt 102 is run, belt encoder 101 may provide a sequence of signals to sensor controller 150 that indicate when a timing marking or indicator on conveyer belt 102 or a separate timing belt has been encountered. The timing markings or indicators may be spaced evenly. Belt offset 210 may be used subsequently to determine the number of belt steps that conveyer belt 102 must be run in order to obtain for a number of objects on conveyer belt 102 in area 102A with respect to camera 105 a similar position in area 102B with respect to camera 106. The first and the second images are used to form a perspective correction to bring the first and the second images to a common coordinate system. The perspective correction is a mapping of points in at least one of the first and the second image to a coordinate system where the difference with respect to differences in the positions of camera 105 and camera 106 in relation to the plane of conveyer belt 102 is compensated. The first and the second image may be transformed to a third perspective plane. The third perspective plane may be orthogonal to the plane of the conveyer belt 102.

The embodiments of the invention described hereinbefore regarding FIG. 2 may be used in any combination with each other. Several of the embodiments may be combined together to form a further embodiment of the invention.

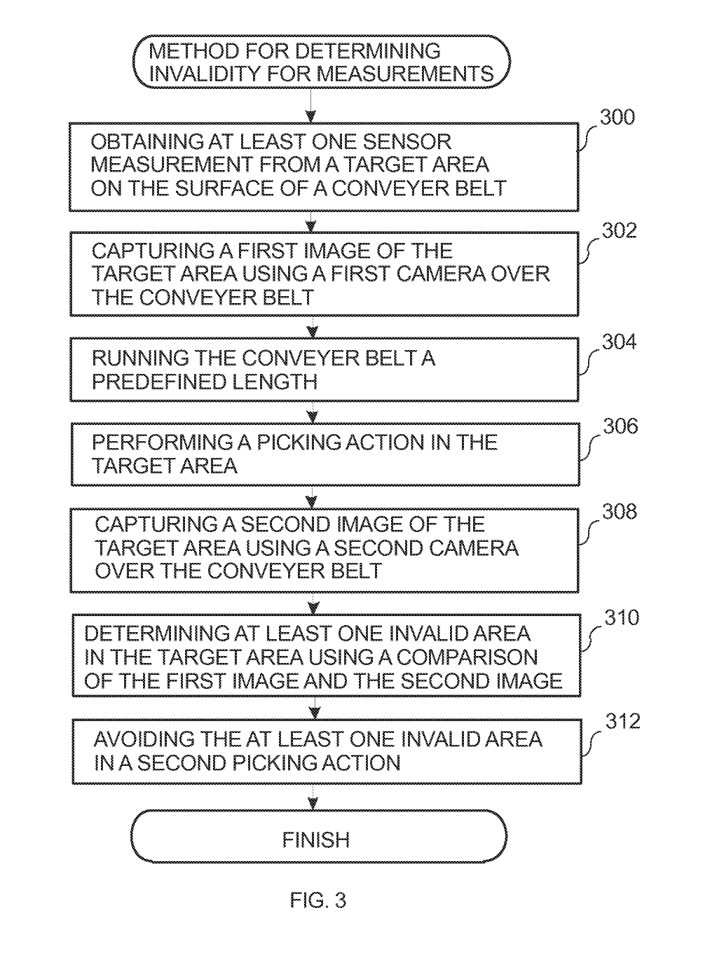

FIG. 3 is a flow chart illustrating a method for invalidating sensor measurements after a picking action in a robot system in one embodiment of the invention.

The method may be applied in a robot system as illustrated in FIGS. 1 and 2.

At step 300, at least one sensor measurement from a target area on a conveyer belt is obtained.

In one embodiment of the invention, the at least one sensor measurement may be a matrix of sensor measurements.

In one embodiment of the invention, the matrix of sensor measurements is obtained from a stationary array of sensors by running the conveyer belt. The conveyer belt may be run so that it captures a time series of measurement from each sensor. The time series may represent columns in the matrix, whereas a sensor identifier may represent rows in the matrix, or vice versa.

At step 302, a first image of the target area is captured using a camera mounted over the conveyer belt.

In one embodiment of the invention, the camera is mounted over the conveyer belt so that sensor arrays do not impede the capturing of an image of the whole target area.

At step 304, the conveyer belt is run a predefined length.

In one embodiment of the invention, the predefined length is determined so that a second camera may capture a second image of the target area so that the first and second images may be transformed to a common coordinate system with at least one of a perspective correction and scrolling.

At step 306, a robot arm performs a picking action in the target area. The picking action may disturb the position of at least one object in the target area.

At step 308, a second image of the target area is captured using the second camera after the picking action.

At step 310, at least one invalid area in the target area is determined using a comparison of the first and the second images.

In one embodiment of the invention, the first and the second images are transformed to a common coordinate system using at least one of a perspective transformation and a scrolling of either image in relation to the other, before comparing the first and the second images.

In one embodiment of the invention, the first image and the second image may be divided to a plurality of areas for the comparison.

In one embodiment of the invention, a plurality of areas is formed from the first and the second images. The plurality of areas may be at least partly overlapping or distinct. The plurality of areas may be formed of the entire areas of the first and the second images with a window function. The window function may be, for example, a rectangular window function or it may be a Gaussian window function. A given area may be obtained from an entire area of an image so that pixel values are multiplied with window function values. Non-zero pixel values or pixel values over a predefined threshold value may be selected from the entire area of the image to the area. The areas may be, for example, pixel blocks of defined height and width such as, for example, 30 times 30 pixels. The plurality of areas may have the same pixels in the first and the second images and may have the same sizes.

In one embodiment of the invention, a Gaussian kernel may be used to smooth at least one of the first and the second image before the comparison. The smoothing may be performed in the plurality of areas formed from the first and the second images.

In one embodiment of the invention, the first image and the second image may be high-pass filtered before the comparison. In one embodiment of the invention, the areas with highest local variance in the first image are determined. The local variance for an area A is computed, for example, using the formula

$$\frac{1}{n} {\sum }_{( x , y ) ∈ A} S ( {I}_{1} ( x , y ) * {I}_{1} ( x , y ) ) - S ( {I}_{1} ( x , y ) * {I}_{1} ( x , y ) )$$

wherein S is a smoothing function, for example, a Gaussian kernel, and I₁ is a pixel in the first image and x and y are the pixel coordinates and n is the number of pixels in area A.

In one embodiment of the invention, the areas with lowest local correlation between the first image and the second image are determined. The local correlation for an area A within the first image and the second image are computed, for example, using the formula

$$\frac{1}{n} {\sum }_{( x , y ) ∈ A} \frac{S ( {I}_{1} ( x , y ) * {I}_{2} ( x , y ) )}{\sqrt{( S ( {I}_{1} ( x , y ) * {I}_{1} ( x , y ) ) * S ( {I}_{2} ( x , y ) * {I}_{2} ( x , y ) ) )}}$$

wherein S is a smoothing function, for example, a Gaussian kernel, I₁ is a pixel in the first image, I₂ is the pixel in the second image and x and y are the pixel coordinates and n is the number of pixels in area A.

In one embodiment of the invention, for each area A, a displacement dx, dy between the area A in the first image and the area B in the second image, wherein −m<dx<m and −m<dy<m and m is a small natural number, for example, 0=<m<5, is determined which yields the highest local correlation. The highest local correlation for an area A is taken as the local correlation for the area A.

In one embodiment of the invention, a number of areas with highest local variance and lowest local correlation are selected as invalid and recorded in a memory. The invalid areas are avoided in at least one subsequent picking action.

In one embodiment of the invention, in the comparison as invalid areas are selected areas with low correlation between the first image and the second image. In one embodiment of the invention, in the comparison as invalid areas are selected areas with low correlation between the first image and the second image and with high local variance within at least one of the first image and the second image.

In one embodiment of the invention, as selection criteria for invalid areas may also be used a threshold for local variance within the first image that must be exceeded and a threshold for local correlation between the first image and the second that must not be exceeded for an area to qualify as an invalid area.

In one embodiment of the invention, for each measurement in the matrix is determined whether it belongs to an invalid area.

At step 312, the at least one invalid area in the target area is avoided in at least one subsequent picking action by the robot arm. The reason is that sensor measurements performed in the invalid areas no longer reflect the positions of the objects after the picking action.

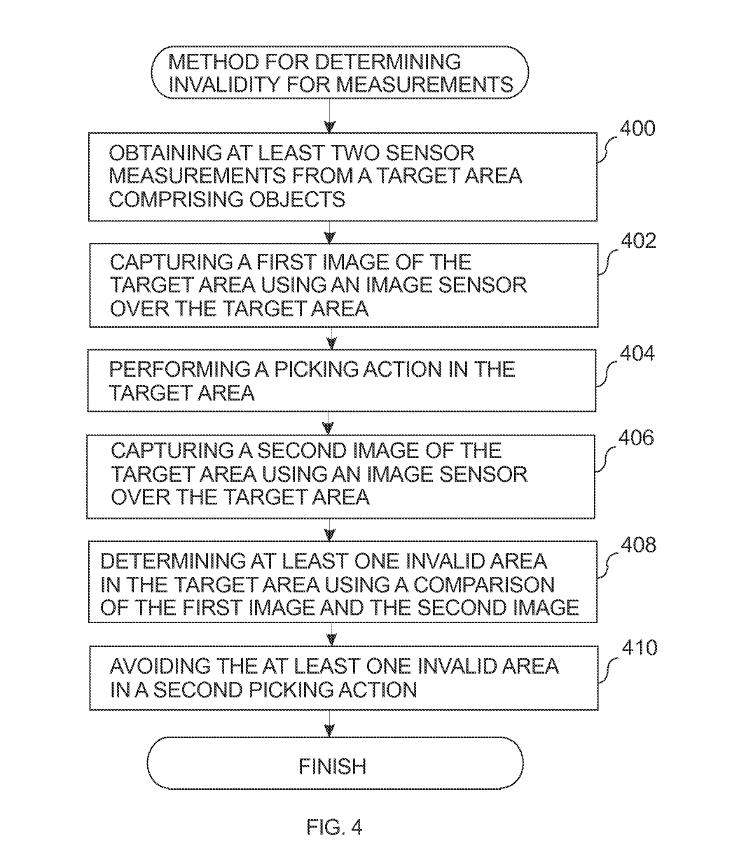

FIG. 4 is a flow chart illustrating a method for invalidating sensor measurements after a picking action in a robot system in one embodiment of the invention. The picking action may be failed and may only result in a moving of an object or the changing of the position or the shape of an object. The picking action may be a mere touch of an object or the target area.

The method may be applied in a robot system as illustrated in FIGS. 1 and 2.

At step 400, at least two sensor measurements from a target area are obtained. The target area may be stationary or moving on a conveyer belt.

In one embodiment of the invention, the at least two sensor measurements may be a matrix of sensor measurements.

In one embodiment of the invention, the matrix of sensor measurements is obtained from a stationary array of sensors by running the conveyer belt.

The conveyer belt may be run so that it captures a time series of measurement from each sensor. The time series may represent columns in the matrix, whereas a sensor identifier may represent rows in the matrix, or vice versa.

In one embodiment of the invention, the matrix of sensor measurements is formed using a moving array of sensors over a stationary target area.

At step 402, a first image of the target area is captured using an image sensor over the target area. There is at least one image sensor over the target area. The at least one image sensor may be, for example, a camera, a laser scanner or a 3D camera. The at least one image sensors may not be strictly over the target area, but at a position that enables the capturing of an image of the target area without objects or sensors acting as obstacles impeding the view of other objects.

In one embodiment of the invention, the camera is mounted over the conveyer belt so that sensor arrays do not impede the capturing of an image of the whole target area.

In one embodiment of the invention, the conveyer belt may be run a predefined length after the steps of obtaining the at least two sensor measurements and the capturing of the first image.

In one embodiment of the invention, the predefined length is determined so that a second camera may capture a second image of the target area so that the first and second images may be transformed to a common coordinate system with at least one of a perspective correction and scrolling.

At step 404, a robot arm performs a picking action in the target area. The picking action may disturb the position of at least one object in the target area.

At step 406, a second image of the target area is captured using an image sensor over the target area after the picking action. There is at least one image sensor over the target area. The at least one image sensor may be, for example, a camera, a laser scanner or a 3D camera. The at least one image sensors may not be strictly over the target area, but at a position that enables the capturing of an image of the target area without objects or sensors acting as obstacles impeding the view of other objects.

At step 408, at least one invalid area in the target area is determined using a comparison of the first and the second images.

In one embodiment of the invention, the first and the second images are transformed to a common coordinate system using at least one of a perspective transformation and a scrolling of either image in relation to the other, before comparing the first and the second images.

In one embodiment of the invention, a plurality of areas is formed of the first and the second images. The plurality of areas may be at least partly overlapping or distinct. The areas may be subsets of the entire areas of the first and the second images. The areas of the first and the second images may have the same pixels, however, with different pixel values in the first and the second images. The plurality of areas may be formed of the entire areas of the first and the second images with a window function. The window function may be, for example, a rectangular window function or it may be a Gaussian window function. A given area may be obtained from an entire area of an image so that pixel values are multiplied with window function values. Non-zero pixel values or pixel values over a predefined threshold value may be selected from the entire area of the image to the area. Different areas may be formed from the entire area of an image so that window functions that produce same values for different domains are formed. The areas may be, for example, pixel blocks of defined height and width such as, for example, 30 times 30 pixels. The plurality of areas may have the same pixels in the first and the second images and may have the same sizes.

In one embodiment of the invention, a Gaussian kernel may be used to smooth at least one of the first and the second image before the comparison. The smoothing may be performed in the plurality of areas formed from the first and the second image.

In one embodiment of the invention, the first image and the second image may be high-pass filtered before the comparison. The areas may be pixel blocks of defined height and width such as, for example, 30 times 30 pixels.

In one embodiment of the invention, the areas with highest local variance in the first image are determined. Alternatively, the areas that exceed a predefined threshold of local variance may be determined. The local variance for an area A is computed, for example, using the formula

$$\frac{1}{n} {\sum }_{( x , y ) ∈ A} S ( {I}_{1} ( x , y ) * {I}_{1} ( x , y ) ) - S ( {I}_{1} ( x , y ) * {I}_{1} ( x , y ) )$$

wherein S is a smoothing function, for example, a Gaussian kernel, and I₁ is a pixel in the first image and x and y are the pixel coordinates and n is the number of pixels in area A.

In one embodiment of the invention, the areas with lowest local correlation between the first image and the second image are determined. Alternatively, the areas that are below a predefined threshold of local correlation may be determined. The local correlation for an area A within the first image and the second image are computed, for example, using the formula

$$\frac{1}{n} {\sum }_{( x , y ) ∈ A} \frac{S ( {I}_{1} ( x , y ) * {I}_{2} ( x , y ) )}{\sqrt{( S ( {I}_{1} ( x , y ) * {I}_{1} ( x , y ) ) * S ( {I}_{2} ( x , y ) * {I}_{2} ( x , y ) ) )}}$$

wherein S is a smoothing function, for example, a Gaussian kernel, I₁ is a pixel in the first image, I₂ is the pixel in the second image and x and y are the pixel coordinates and n is the number of pixels in area A.

In one embodiment of the invention, for each area A, a displacement dx, dy between the area A in the first image and the area B in the second image, wherein −m<dx<m and −m<dy<m and m is a small natural number, for example, 0=<m<5, is determined which yields the highest local correlation. The highest local correlation for an area A is taken as the local correlation for the area A.

In one embodiment of the invention, a number of areas with highest local variance and lowest local correlation are selected as invalid and recorded in a memory. The invalid areas are avoided in at least one subsequent picking action.

In one embodiment of the invention, as selection criteria for invalid areas may also be used a threshold for local variance within the first image that must be exceeded and a threshold for local correlation between the first image and the second that must not be exceeded for an area to qualify as an invalid area.

In one embodiment of the invention, in the comparison as invalid areas are selected areas with low correlation between the first image and the second image. In one embodiment of the invention, in the comparison as invalid areas are selected areas with low correlation between the first image and the second image and with high local variance within at least one of the first image and the second image.

In one embodiment of the invention, for each measurement in the matrix is determined whether it belongs to an invalid area.

In one embodiment of the invention, the comparing of the first and the second image to determine at least one invalid area in the target area further comprises choosing one of the height maps of the first image or the second image, producing from the chosen height map two new height maps, which may be referred to as a min-map and a max-map, the min-map being computed pixel-wise using the formula: min-map=erode(heightmap)−fudgefactor, the max-map being computed pixel-wise using the formula: max-map=dilate(heightmap)+fudgefactor, comparing a second height map h2, that is, the other height map, to the chosen height map h1 by checking for each pixel h2(x,y) in the second height map whether the condition min-map(x,y)<h2(x,y)<max-map(x,y) is fulfilled, and selecting to the at least one invalid area pixels (x,y) for which the condition is not fulfilled. The dilate function is the morphologic dilation operator. The erode function is the morphologic erosion operator. The fudge factor is a constant or a pixel dependent array of constants.

In one embodiment of the invention, the comparing the first image and the second image to determine at least one invalid area in the target area further comprises forming an upper limit surface of a chosen height map, the chosen height map being the height map of the first image or the second image, forming a lower limit surface of the chosen height map, and selecting to the at least one invalid area such areas where the other height map does not fit between the upper limit surface and the lower limit surface, the other height map being the height map of the first image or the second image.

At step 410, the at least one invalid area in the target area is avoided in at least one subsequent picking action by the robot arm. The reason is that sensor measurements performed in the invalid areas no longer reflect the positions of the objects after the picking action.

The embodiments of the invention described hereinbefore regarding FIG. 4 may be used in any combination with each other. Several of the embodiments may be combined together to form a further embodiment of the invention.

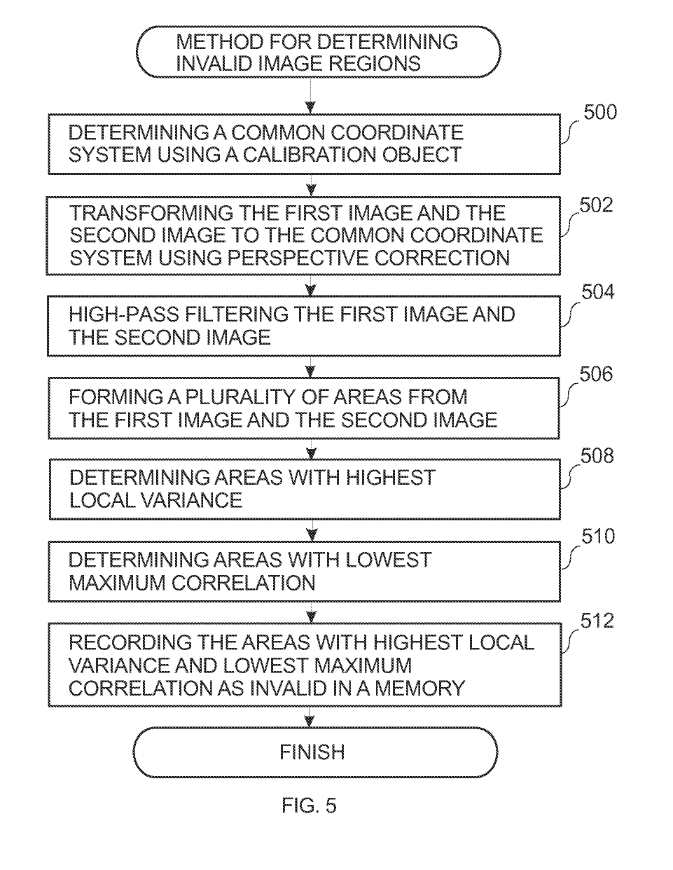

FIG. 5 is a flow chart illustrating a method for determining invalid image areas within a target area in a robot system in one embodiment of the invention.

The method may be applied in a robot system as illustrated in FIGS. 1 and 2, and in a method as illustrated in FIGS. 3 and 4.

At step 500, a common coordinate system is determined for a first image and a second image. The first image represents a target area on a conveyer belt before a picking action has been performed with a robot arm to the target area. The second image represents the target area on a conveyer belt after the picking action has been performed. In one embodiment of the invention, the common coordinate system is determined using a test object with a know shape. In one embodiment of the invention, the test object is as illustrated in FIG. 2.

At step 502, at least one of the first image and the second image are transformed to a common coordinate system using perspective correction. The first and the second image may be transformed to a third perspective plane. The third perspective plane may be orthogonal to the plane of the conveyer belt.

At step 504, at least one of the first and the second image are high-pass filtered. The high-pass filtering may be used to remove differences in light conditions and reflections.

At step 506, a plurality of areas is formed of the first and the second images. The plurality of areas may be at least partly overlapping or distinct. The plurality of areas may be formed of the entire areas of the first and the second images with a window function. The window function may be, for example, a rectangular window function or it may be a Gaussian window function. A given area may be obtained from an entire area of an image so that pixel values are multiplied with window function values. Non-zero pixel values or pixel values over a predefined threshold value may be selected from the entire area of the image to the area. The areas may be, for example, pixel blocks of defined height and width such as, for example, 30 times 30 pixels. The plurality of areas may have the same pixels in the first and the second images and may have the same sizes.

At step 508, the areas with highest local variance in the first image are determined. The local variance for an area A is computed, for example, using the formula

$$\frac{1}{n} {\sum }_{( x , y ) ∈ A} S ( {I}_{1} ( x , y ) * {I}_{1} ( x , y ) ) - S ( {I}_{1} ( x , y ) * {I}_{1} ( x , y ) )$$

wherein S is a smoothing function, for example, a Gaussian kernel, and I₁ is a pixel in the first image and x and y are the pixel coordinates and n is the number of pixels in area A.

At step 510, the areas with lowest local correlation between the first image and the second image are determined. The local correlation for an area A within the first image and the second image are computed, for example, using the formula

$$\frac{1}{n} {\sum }_{( x , y ) ∈ A} \frac{S ( {I}_{1} ( x , y ) * {I}_{2} ( x , y ) )}{\sqrt{( S ( {I}_{1} ( x , y ) * {I}_{1} ( x , y ) ) * S ( {I}_{2} ( x , y ) * {I}_{2} ( x , y ) ) )}}$$

wherein S is a smoothing function, for example, a Gaussian kernel, I₁ is a pixel in the first image, I₂ is the pixel in the second image and x and y are the pixel coordinates and n is the number of pixels in area A.

In one embodiment of the invention, for each area A, a displacement dx, dy between the area A in the first image and the area B in the second image, wherein −m<dx<m and −m<dy<m and m is a small natural number, for example, 0=<m<5, is determined which yields the highest local correlation. The highest local correlation for an area A is taken as the local correlation for the area A.

At step 512, a number of areas with highest local variance and lowest local correlation are selected as invalid and recorded in a memory. The invalid areas are avoided in at least one subsequent picking action.

In one embodiment of the invention, to decrease the amount of computations the image data received from the camera is down-sampled to a resolution determined suitable for analysis.

In one embodiment of the invention, the resulting down-sampled image is then normalized to account for changes in lightning conditions. The normalization may be done separately for each pixel in the down-sampled image.

The embodiments of the invention described hereinbefore regarding FIG. 5 may be used in any combination with each other. Several of the embodiments may be combined together to form a further embodiment of the invention.

A method, a system, an apparatus, a computer program or a computer program product to which the invention is related may comprise at least one of the embodiments of the invention described hereinbefore in association with FIG. 1, FIG. 2, FIG. 3 and FIG. 4.

The exemplary embodiments of the invention can be included within any suitable device, for example, including any suitable servers, workstations, PCs, laptop computers, PDAs, Internet appliances, handheld devices, cellular telephones, wireless devices, other devices, and the like, capable of performing the processes of the exemplary embodiments, and which can communicate via one or more interface mechanisms, including, for example, Internet access, telecommunications in any suitable form (for instance, voice, modem, and the like), wireless communications media, one or more wireless communications networks, cellular communications networks, 3 G communications networks, 4 G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware art(s). For example, the functionality of one or more of the components of the exemplary embodiments can be implemented via one or more hardware devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of application-specific integrated circuits or by interconnecting an appropriate network of conventional component circuits, as will be appreciated by those skilled in the electrical art(s).

As stated above, the components of the exemplary embodiments can include computer readable medium or memories according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

It is obvious to a person skilled in the art that with the advancement of technology, the basic idea of the invention may be implemented in various ways. The invention and its embodiments are thus not limited to the examples described above; instead they may vary within the scope of the claims.

1. A method, comprising:
obtaining at least two sensor measurements using at least one sensor from a target area;
forming a first image of the target area;
performing a first sorting action in the target area based on at least a first sensor measurement among the at least two sensor measurements;
forming a second image of the target area;
comparing the first image and the second image to determine an invalid area in the target area, wherein an area with low correlation between the first image and the second image is selected as the invalid area; and
avoiding the invalid area in at least one second sorting action in the target area, the second sorting action being based on at least a second sensor measurement among the at least two sensor measurements.

2. The method according to claim 1, wherein the first image is formed by capturing an image of the target area using a first camera and the second image is formed by capturing an image of the target area using a second camera.

3. The method according to claim 2, the method further comprising:
running a conveyor belt on which the target area is located a predefined length, the predefined length corresponding to a distance between the first camera and a second camera.

4. The method according to claim 3, the method further comprising:
transforming at least one of the first image and the second image to a coordinate system shared by the first image and the second image using perspective correction.

5. The method according to claim 3, the method further comprising:
determining the perspective correction using a test object with known form.

6. The method according to claim 5, the method further comprising:
capturing a plurality of first test images using the first camera and a plurality of second test images using the second camera while the conveyer belt is run;
selecting best matching images among the first test images and the second images representing the test object; and
recording the length the conveyer belt has been run between the images as the predefined length.

7. The method according to claim 1, wherein the step of comparing the first and the second image further comprises:
high-pass filtering at least one of the first image and the second image.

8. The method according to claim 1, wherein the step of comparing the first and the second image further comprises:
forming a plurality of areas of the first image and the second image, the plurality of areas being at least partly overlapping or distinct.

9. The method according to claim 8, wherein the step of comparing the first image and the second image further comprises:
smoothing each of the plurality of areas with a smoothing function.

10. The method according to claim 8, wherein the step of comparing the first and the second image further comprises:
determining a plurality of areas as the at least one invalid area based on a low correlation between the first image and the second image and high variance within the first image.

11. The method according to claim 10, wherein the step of determining a plurality of areas as the at least one invalid area further comprises:
selecting a maximum correlation yielding displacement between the first image and the second image for each area; and
computing the correlation between the first image and the second image for each area using the maximum correlation yielding displacement.

12. The method according to claim 1, wherein the at least one sensor comprises an infrared sensor and a laser scanner.

13. The method according to claim 1, wherein the camera is a visible light camera, time of flight 3D camera, structured light 3D camera or an infrared camera.

14. The method according to claim 1, wherein the first image and the second image are formed using a single 3D camera.

15. The method according to claim 1, wherein the sorting action is performed using a robot arm.

16. The method according to claim 1, wherein the step of comparing the first image and the second image to determine at least one invalid area in the target area further comprises:
assigning as a first height map a height map associated with either the first image or the second image;
assigning as a second height map a height map associated with the other image;
forming an upper limit surface of the first height map;
forming a lower limit surface of the first height map;
and selecting to the at least one invalid area such areas where the second height map does not fit between the upper limit surface and the lower limit surface.

17. An apparatus comprising at least one processor configured
to obtain at least two sensor measurements using at least one sensor from a target area,
to form a first image of the target area,
to perform a first sorting action in the target area based on at least a first sensor measurement among the at least two sensor measurements,
to form a second image of the target area,
to compare the first image and the second image to determine an invalid area in the target area, wherein an area with low correlation between the first image and the second image is selected as the invalid area, and
to avoid the invalid area in at least one second sorting action in the target area, the second sorting action being based on at least a second sensor measurement among the at least two sensor measurements.

18. An apparatus, comprising:
means for obtaining at least two sensor measurements using at least one sensor from a target area;
means for forming a first image of the target area;
means for performing a first sorting action in the target area based on a first sensor measurement among the at least two sensor measurements;
means for forming a second image of the target area;
means for comparing the first and the second image to determine an invalid area in the target area, wherein an area with low correlation between the first image and the second image is selected as the invalid area; and
means for avoiding the invalid area in at least one second sorting action in the target area, the second sorting action being based on at least a second sensor measurement among the at least two sensor measurements.

19. A computer program comprising code adapted to cause a processor to perform the following steps when executed on a data-processing system:
obtaining at least two sensor measurements using at least one sensor from a target area;
forming a first image of the target area;
performing a first sorting action in the target area based on at least a first sensor measurement among the at least two sensor measurements;
forming a second image of the target area;
comparing the first image and the second image to determine an invalid area in the target area, wherein an area with low correlation between the first image and the second image is selected as the invalid area; and
avoiding the invalid area in at least one second sorting action in the target area, the second sorting action being based on at least a second sensor measurement among the at least two sensor measurements.

20. The computer program according to claim 19, wherein said computer program is stored on a computer readable medium.
